(19) United States
(12) Patent Application Publication
(10) Pub. No.: US 2021/0016764 A1
(43) Pub. Date: Jan. 21, 2021

(54) STEERING ASSEMBLY FOR A VEHICLE, VEHICLE COMPRISING THE SAME AND METHOD FOR CONTROLLING MOTION OF A VEHICLE USING A STEERING ASSEMBLY

(71) Applicant: ATHÉNA TECHNOLO-G INC., Lorraine (CA)

(72) Inventor: Eric Deschamps, Lorraine (CA)

(21) Appl. No.: 16/979,752

(22) PCT Filed: Mar. 8, 2019
(86) PCT No.: PCT/CA2019/050289

§ 371 Date: Sep. 10, 2020

Related U.S. Application Data
(60) Provisional application No. 62/641,688, filed on Mar. 12, 2018.

(51) Int. Cl. B60W 10/20; B60L 15/20; B60W 10/08; B62D 11/00; B62D 11/04

(52) U.S. Cl. CPC B60W 10/20; B60L 15/2036; B60W 2710/081; B62D 11/003; B62D 11/04; B60W 10/08

(57) ABSTRACT

A steering assembly for a vehicle having a front end and a rear end, the steering assembly comprising: a steering beam configured to pivot relative to the vehicle frame about a beam pivot axis; left and right wheels rotatably connected to the steering beam; left and right wheel motors for rotating the left and right wheels respectively; a controller for controlling a rotation speed of the wheels, the controller being configured to allow the rotation speed of the left wheel to be adjusted to a first rotation speed and the rotation speed of the right wheel to be simultaneously adjusted to a second rotation speed different from the first rotation speed to cause the steering beam to pivot relative to the frame about the beam pivot axis when the left and right wheels contact a ground surface.

### TECHNICAL FIELD

The technical field generally relates to steering assemblies for land vehicles, and more specifically for steering assemblies for land vehicles including individually powered wheels. The technical field further relates to vehicles comprising steering assemblies and to methods for controlling motion of a vehicle travelling on a ground surface.

### BACKGROUND

Typically, powered vehicles such as automobiles (e.g. passenger cars, trucks, motorcycles and four wheels ATVs) are designed around a propulsive mean (engine or motor(s)) that solely controls the acceleration and deceleration of the vehicle. Furthermore, traditional automobiles comprise running gears that, taken individually, are each assigned to fulfill a particular function during the vehicle's operation. For example, transmissions are meant to adjust the propulsive means' speed to the desired vehicle's torque and speed, brakes are meant to decelerate or stop the vehicle, suspensions are meant to absorb the ground irregularities and maintain proper tires adhesion, and steering gear is meant to steer the vehicle. With advances in power electronics, all these systems have increased means of communication but limited means of interactions and remain assigned to their initial role for the most part.

Furthermore, in autonomous vehicles in which the vehicle's systems are no longer operated by direct human interactions, an actuator may instead be assigned to each of the vehicle's systems. In this case, each actuator will require its own envelope as well as its own energy source. An autonomous vehicle will thus increase in complexity and be less efficient than initially envisioned since it will have to tap into a limited onboard energy provision to power its arrays of actuators.

There is therefore a need for a steering assembly which will address at least one of the above considerations. More specifically, there is a need for a system which will dispense with at least some of the above-identified steering assembly components normally found on conventional vehicles while reducing or even eliminating the need to supply additional power to steer the vehicle.

### SUMMARY

According to one aspect, there is provided a steering assembly for a vehicle, the vehicle including a vehicle frame having a front end and a rear end, the steering assembly comprising: a steering beam having a left end and a right end, the steering beam being pivotably connectable to the vehicle frame such that the left end is located towards a left side of the vehicle and the right end is located towards a right side of the vehicle, the steering beam being configured to pivot relative to the vehicle frame about a beam pivot axis located between the first and second ends of the steering beam and extending through the steering beam; left and right wheels rotatably connected to the steering beam respectively at the left and right ends thereof, the left and right wheels being rotatable relative to the steering beam respectively about left and right wheel axes extending away from the steering beam, the left and right wheels maintaining the left and right ends of the steering beam in a beam plane parallel to the ground surface when the left and right wheels contact the ground surface such that, when the steering beam is pivoted, the left and right ends of the steering beam move around the beam pivot axis while remaining within the beam plane; a left wheel motor secured to the steering beam at the left end thereof, the left wheel motor being operatively connected to the left wheel for rotating the left wheel; a right wheel motor secured to the steering beam at the right end thereof, the right wheel motor being operatively connected to the right wheel for rotating the right wheel; a controller operatively connected to the left wheel motor and to the right wheel motor for controlling a rotation speed of the left and right wheels, the controller being configured to allow the rotation speed of the left wheel to be adjusted to a first rotation speed and to allow the rotation speed of the right wheel to be simultaneously adjusted to a second rotation speed different from the first rotation speed to thereby cause the steering beam to pivot relative to the vehicle frame about the beam pivot axis when the left and right wheels contact the ground surface.

In at least one embodiment, the beam pivot axis extends at an angle relative to a vertical axis which extends orthogonally to the ground surface when the left and right wheels contact the ground surface.

In at least one embodiment, the beam pivot axis is angled such that it slopes down from one of the front and rear ends of the vehicle frame towards the other one of the front and rear ends of the vehicle frame.

In at least one embodiment, the beam pivot axis is angled at a pivot angle of between about 0 degrees and 45 degrees relative to the vertical axis.

In at least one embodiment, the beam pivot axis is angled at a pivot angle of about 15 degrees relative to the vertical axis.

In at least one embodiment, the beam pivot axis is centered between the left and right ends of the steering beam.

In at least one embodiment, the steering assembly further comprises a pivot axle extending along the beam pivot axis and pivotably connecting the steering beam to the vehicle frame.

In at least one embodiment, the vehicle frame defines a median longitudinal plane extending orthogonally to the ground surface when the vehicle is travelling forward on the ground surface, the pivot axle extending along the median longitudinal plane.

In at least one embodiment, the steering assembly further comprises a bracket secured to the vehicle frame for receiving the pivot axle and for restricting movement of the pivot axle to allow only rotation of the pivot axle about the beam pivot axis.

In at least one embodiment, the bracket includes a lower bracket member and an upper bracket member disposed above the lower bracket member, the lower and upper bracket members being spaced apart from each other to receive the steering beam therebetween.

In at least one embodiment, the bracket includes a bracket member disposed below the steering beam.

In at least one embodiment, the bracket includes a bracket member disposed above the steering beam.

In at least one embodiment, the steering assembly further comprises a resilient member operatively connected to the steering beam and to the bracket to urge the steering beam back towards a forward-facing orientation when the steering beam is pivoted about the beam pivot axis away from the forward-facing orientation.

In at least one embodiment, the resilient element includes a torsion spring concentrically mounted around the pivot axle.

In at least one embodiment, the steering beam includes a central sleeve sized and shaped for receiving the pivot axle, and left and right steering arms hingeably connected to the central sleeve.

In at least one embodiment, the steering assembly further comprising a leaf spring member resiliently connecting together the left and right steering arms to the central sleeve.

In at least one embodiment, each steering arm includes a wheel mounting body engaging a corresponding wheel and upper and lower arm members extending between the central sleeve and the wheel mounting body, the upper and lower arm members being hingeably connected to the central sleeve and to the wheel mounting body so as to define a four-bar linkage arrangement for allowing the corresponding wheel to move upwardly and downwardly relative to the central sleeve.

In at least one embodiment, the steering assembly further comprises a leaf spring member resiliently connecting together the wheel mounting body of the left steering arm and the wheel mounting body of the right steering arm to the central sleeve.

In at least one embodiment, the first and second motors include wheel hub motors.

In at least one embodiment, the controller is mounted on the vehicle frame.

In at least one embodiment, the controller is remote from the vehicle frame and is adapted to send commands wirelessly to at least one communication unit mounted on the vehicle frame, the communication unit being operatively connected to the left and right wheel motors to adjust the rotation speed of the left and right wheel according to the commands received from the controller.

In at least one embodiment, the steering beam has an oblong cross-section.

In at least one embodiment, the steering beam includes planar top and bottom faces extending parallel to each other.

According to another aspect, there is also provided a vehicle comprising: a vehicle frame having a front end and a rear end; at least one steering assembly, each steering beam assembly being secured to the vehicle frame towards one of the front and rear ends thereof, each steering assembly including: a steering beam having a left end and a right end, the steering beam being pivotably connectable to the vehicle frame such that the left end is located towards a left side of the vehicle and the right end is located towards a right side of the vehicle, the steering beam being configured to pivot relative to the vehicle frame about a beam pivot axis located between the first and second ends of the steering beam and extending through the steering beam; left and right wheels rotatably connected to the steering beam respectively at the left and right ends thereof, the left and right wheels being rotatable relative to the steering beam respectively about left and right wheel axes extending away from the steering beam, the left and right wheels maintaining the left and right ends of the steering beam in a beam plane parallel to the ground surface when the left and right wheels contact the ground surface such that, when the steering beam is pivoted, the left and right ends of the steering beam move around the beam pivot axis while remaining within the beam plane; a left wheel motor secured to the steering beam at the left end thereof, the left wheel motor being operatively connected to the left wheel for rotating the left wheel; a right wheel motor secured to the steering beam at the right end thereof, the right wheel motor being operatively connected to the right wheel for rotating the right wheel; a controller operatively connected to the left wheel motor and to the right wheel motor for controlling a rotation speed of the left and right wheels, the controller being configured to allow the rotation speed of the left wheel to be adjusted to a first rotation speed and to allow the rotation speed of the right wheel to be simultaneously adjusted to a second rotation speed different from the first rotation speed to thereby cause the steering beam to pivot relative to the vehicle frame about the beam pivot axis when the left and right wheels contact the ground surface.

In at least one embodiment, the pivot axis extends at an angle relative to a vertical axis which extends orthogonally to the ground surface when the left and right wheels contact the ground surface.

In at least one embodiment, the at least one steering assembly includes a plurality of steering assemblies.

In at least one embodiment, the plurality of steering assemblies includes at least one front steering subassembly secured to the front end of the vehicle frame and at least one rear steering subassembly secured to the rear end of the vehicle frame.

In at least one embodiment, the at least one front steering subassembly include first and second front steering subassemblies.

In at least one embodiment, the at least one rear steering subassembly include first and second rear steering subassemblies.

According to yet another aspect, there is provided a vehicle comprising: a vehicle frame having a front end and a rear end; a steering assembly including a front steering subassembly secured to the front end of the frame and a rear steering subassembly secured to the rear end of the frame, each one of the front and rear steering subassemblies including: a steering beam having a left end and a right end, the steering beam being pivotably connectable to the vehicle frame such that the left end is located towards a left side of the vehicle and the right end is located towards a right side of the vehicle, the steering beam being configured to pivot relative to the vehicle frame about a beam pivot axis located between the first and second ends of the steering beam and extending through the steering beam; left and right wheels rotatably connected to the steering beam respectively at the left and right ends thereof, the left and right wheels being rotatable relative to the steering beam respectively about left and right wheel axes extending away from the steering beam, the left and right wheels maintaining the left and right ends of the steering beam in a beam plane parallel to the ground surface when the left and right wheels contact the ground surface such that, when the steering beam is pivoted, the left and right ends of the steering beam move around the beam pivot axis while remaining within the beam plane; a left wheel motor secured to the steering beam at the left end thereof, the left wheel motor being operatively connected to the left wheel for rotating the left wheel; a right wheel motor secured to the steering beam at the right end thereof, the right wheel motor being operatively connected to the right wheel for rotating the right wheel; a controller operatively connected to the first and second motors of the front subassembly and to the first and second motors of the rear subassembly for controlling a rotation speed of the left and right wheels of the front and rear steering subassemblies, the controller being configured to allow the rotation speed of the left wheel of the front steering subassembly to be adjusted to a first rotation speed and to allow the rotation speed of the right wheel of the front steering subassembly to be simultaneously adjusted to a second rotation speed different from the first rotation speed to cause the steering beam of the front steering subassembly to pivot relative to the frame about the corresponding beam pivot axis in a first pivot direction when the left and right wheels contact a ground surface, the controller being further configured to allow the left wheel of the rear steering assembly to be adjusted to a third rotation speed and to allow the rotation speed of the right wheel of the rear steering assembly to be simultaneously adjusted to a fourth rotation speed different from the third rotation speed to cause the steering beam of the rear steering subassembly to pivot relative to the vehicle frame about the corresponding beam pivot axis in a second pivot direction opposite the first pivot direction when the left and right wheels contact the ground surface.

In at least one embodiment, each beam pivot axis extends at an angle relative to a vertical axis which extends orthogonally to the ground surface when the left and right wheels contact the ground surface.

In at least one embodiment, the beam pivot axis of the front steering subassembly is angled such that it slopes down from the front end of the vehicle frame towards the rear end of the vehicle frame.

In at least one embodiment, the beam pivot axis of the rear steering subassembly is angled such that it slopes down from the rear end of the vehicle frame towards the front end of the vehicle frame.

In at least one embodiment, the beam pivot axes of both the front and rear steering subassemblies are angled at a pivot angle of between about 0 degrees and 45 degrees relative to the vertical axis.

In at least one embodiment, the beam pivot axes of both the front and rear steering subassemblies are angled at a pivot angle of about 15 degrees relative to the vertical axis.

According to yet another aspect, there is provided a method for controlling motion of a vehicle travelling on a ground surface, the method comprising: providing a steering assembly for the vehicle, the steering assembly including a steering beam being pivotably connected to a vehicle frame of the vehicle, the steering beam having left and right ends, the steering assembly further including left and right wheels rotatably mounted respectively to left and right ends of the steering beam, the left and right wheels being rotatable relative to the steering beam respectively about left and right wheel axes extending away from the steering beam, the left and right wheels maintaining the left and right ends of the steering beam in a beam plane parallel to the ground surface; adjusting a rotation speed of the left wheel to a first rotation speed; adjusting a rotation speed of the right wheel to a second rotation speed different from the first speed to thereby cause the steering beam to pivot relative to the vehicle frame about a beam pivot axis extending through the steering beam such that the left and right ends of the steering beam move around the beam pivot axis while remaining within the beam plane.

In at least one embodiment, the adjusting of the rotation speed of the right wheel to the second rotation speed is simultaneous to the adjusting of the rotation speed of the left wheel to the first rotation speed.

In at least one embodiment, the method further comprises: reducing the rotation speed of the left wheel; simultaneously reducing the rotation speed of the right wheel to thereby cause the vehicle to brake.

In at least one embodiment, the method further comprises: using a vibration sensor, measuring vibrations in at least one of the left and right wheels and the vehicle frame over a period of time; determining a vibration frequency of the vibrations based on the measured vibrations; modulating the rotation speed of at least one of the left and right wheels according to the determined vibration frequency to thereby damp vibrations in the at least one of the left and right wheels and the vehicle frame

### BRIEF DESCRIPTION OF THE DRAWINGS

FIG. 1 is a top front perspective view of a vehicle including a steering assembly, in accordance with one embodiment, with the vehicle being shown in dotted lines and being steered in a normal forward travel direction;

FIG. 2 is a left side elevation view of the vehicle and the steering assembly illustrated in FIG. 1;

FIG. 3 is a front elevation view of the vehicle and the steering assembly illustrated in FIG. 1;

FIG. 4 is a top plan view of the vehicle and the steering assembly illustrated in FIG. 1;

FIG. 5 is a left side elevation view of the vehicle and the steering assembly illustrated in FIG. 1, with the steering assembly configured to allow the vehicle to make a left turn;

FIG. 6 is a front elevation view of the vehicle and the steering assembly illustrated in FIG. 1, with the steering assembly configured to allow the vehicle to make a left turn;

FIG. 7 is a top plan view of the vehicle and the steering assembly illustrated in FIG. 1, with the steering assembly configured to allow the vehicle to make a left turn;

FIG. 8 is a top front perspective view of a front steering subassembly for the steering assembly illustrated in FIG. 1, in accordance with one embodiment;

FIG. 9 is a schematic drawing showing a cross-section view of the front steering subassembly illustrated in FIG. 8, taken along cross-section plane D;

FIG. 10 is a top front perspective view of a front steering subassembly for the steering assembly illustrated in FIG. 1, in accordance with another embodiment;

FIG. 11A is a top front perspective view of a front steering subassembly for the steering assembly illustrated in FIG. 1, in accordance with yet another embodiment;

FIG. 11B is a top rear perspective view of the front steering subassembly illustrated in FIG. 11A;

FIG. 12A is a top front perspective view of a front steering subassembly for the steering assembly illustrated in FIG. 1, in accordance with still yet another embodiment;

FIG. 12B is a top rear perspective view of the front steering subassembly illustrated in FIG. 12A;

FIG. 13 is a top front perspective view of a vehicle including a steering assembly, in accordance with yet another embodiment, with the vehicle being shown in dotted lines;

FIG. 14 is a top front perspective view of a vehicle including a steering assembly, in accordance with still another embodiment, with the vehicle being shown in dotted lines; and

FIG. 15 is a top front perspective view of a vehicle including a steering assembly, in accordance with yet another embodiment, with a user straddling a frame of the vehicle.

### DETAILED DESCRIPTION

The present concerns a steering assembly for a vehicle which includes wheels which are mounted to a non-rotating steering beam rather than a rotating axle. The steering beam is adapted to pivot relative to a frame of the vehicle about a beam pivot axis. The wheels are further powered and are operatively connected to a controller which can adjust individually the rotation speed of each wheel. The combination of these features allows the vehicle to turn in both directions while following a large array of radii without necessitating any additional dedicated steering apparatus.

In one embodiment, the pivot axis is angled relative to a vertical axis (i.e. an axis which is generally orthogonal or normal to a ground surface on which the vehicle is travelling), rather than being fully vertical. When the vehicle is turning, this configuration causes the sprung mass of the vehicle to be displaced by rolling towards the inside of the turn as opposed to towards the outside of the turn as is the case in conventional road vehicles. This reduces the effect of the weight transfer induced by body roll of the vehicle during transient response and thus increase the capacity of the entire wheeltrain to generate side adhesion on the ground surface. By doing so, it also increases the comfort of passengers inside the vehicle by counteracting the effect of centrifugal acceleration on their body.

Furthermore, all the connections between the wheeltrain and the vehicle's sprung mass may be generally located along the vehicle's median longitudinal plane. For example, in at least one embodiment, the steering beam is connected to the vehicle frame via a pivot axle which is generally centered in a transverse direction between the left and right sides of the vehicle. This configuration improves the vehicle's polar moments of inertia. This configuration further reduces the torsional stresses to which the vehicle's frame is subjected. The vehicle frame is therefore not required to be as rigid as it would be with a conventional steering system, and its weight may therefore be reduced.

These and other features will become apparent from the following description and appended drawings.

In the following description, the terms “front”, “rear”, “left” and “right” are used in relation to a normal forward travel direction A of the vehicle, as is common in the art.

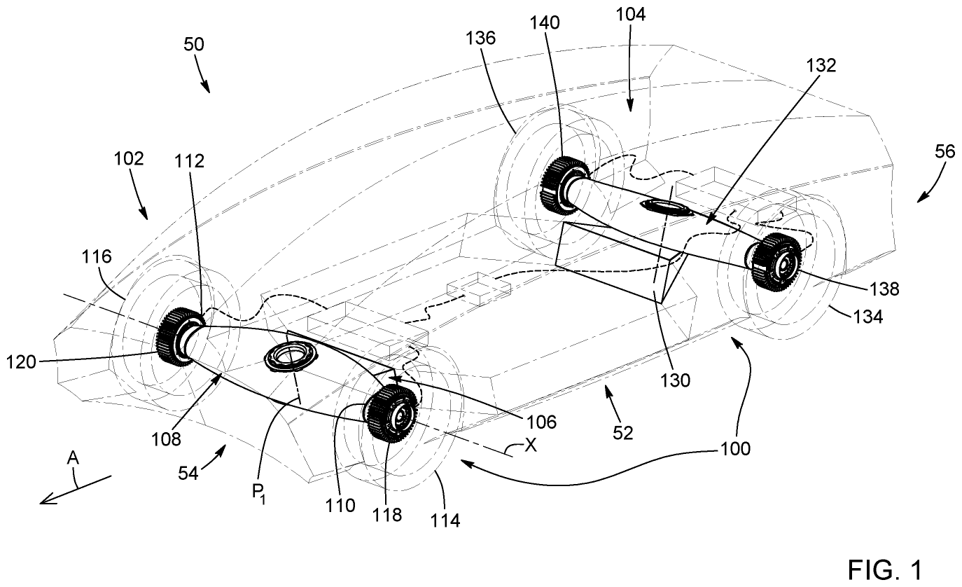

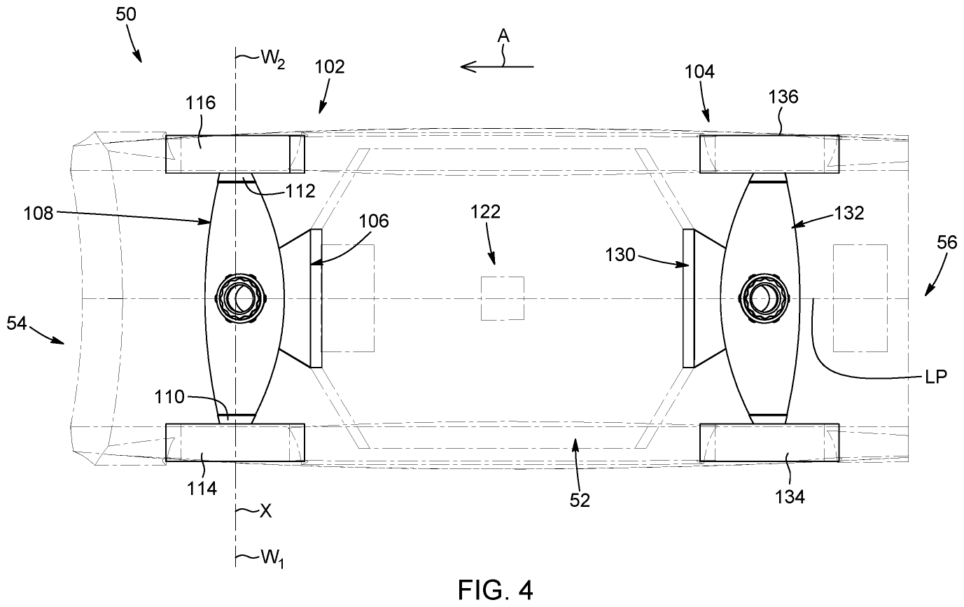

Referring first to FIGS. 1-4, there is shown a vehicle 50 (shown in dotted lines) having a vehicle frame 52 and a steering assembly 100, in accordance with one embodiment, which is secured to the vehicle frame 52.

The steering assembly 100 includes a front steering subassembly 102 located near a front end 54 of the vehicle frame 52 and a rear steering subassembly 104 located near a rear end 56 of the vehicle frame 52.

The front steering subassembly 102 includes a front bracket 106 secured to the vehicle frame 52 and a front steering beam 108 pivotably connected to the front bracket 106. In the embodiment illustrated in FIGS. 1-4, the front bracket 106 extends forwardly from the front end 54 of the vehicle frame 52 and the front steering beam 108 extends generally transversely relative to the vehicle frame 52, above the front bracket 106. Specifically, the front steering beam 108 includes a left end 110 which is located towards a left side of the vehicle 50 and a right end 112 which is located towards a right side of the vehicle 50.

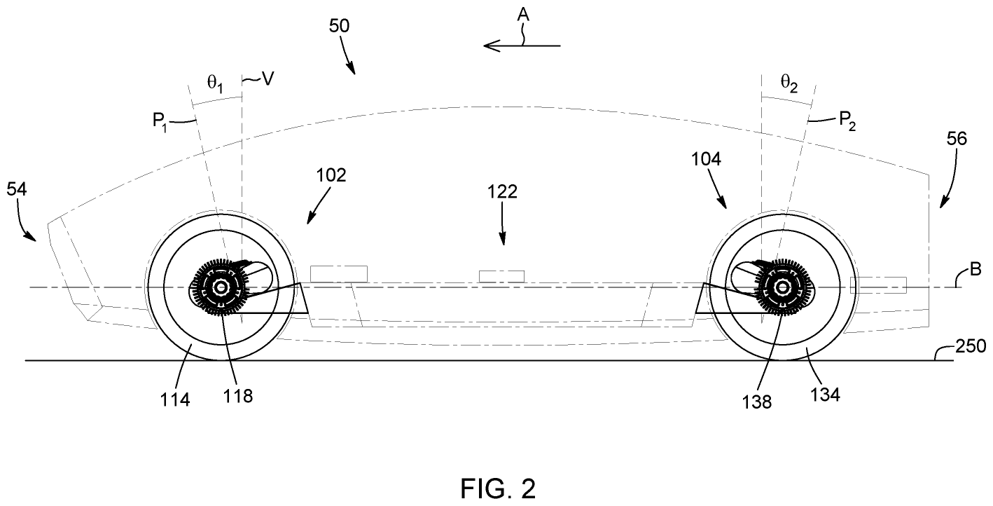

Still referring to FIGS. 1-4, the front steering subassembly 102 further includes left and right front wheels 114, 116 (also shown in dotted lines in FIG. 1, but shown in solid lines in FIGS. 2-4) rotatably connected to the front steering beam 108 respectively at the left and right ends 110, 112 of the front steering beam 108.

The front steering beam 108 further defines a beam axis X which extends generally through the front steering beam 108 between the left and right ends 110, 112 of the front steering beam 108. In the illustrated embodiment, the front steering beam 108 is generally straight and linear, and therefore the beam axis X extends generally through a major axis of the front steering beam 108. Alternatively, the front steering beam 108 may not be straight or linear. For example, the front steering beam 108 could instead be curved.

The left and right front wheels 114, 116 are further adapted to rotate relative to the front steering beam 108 about left and right wheel axes W₁, W₂, which extend parallel to each other. In the illustrated embodiment, since the front steering beam 108 is generally straight and linear, the left and right wheel axes W₁, W₂ are also parallel to the beam axis X. Alternatively, the left and right wheel axes W₁, W₂ may not be parallel to the beam axis X.

The front steering subassembly 102 further includes a pivot axle or kingpin, not shown, which extends through the front bracket 106 and the front steering beam 108. The pivot axle defines a front beam pivot axis P₁ which allows the front steering beam 108 to pivot relative to the vehicle frame 52. The front beam pivot axis P₁ is located between the left and right ends 110, 112 of the front steering beam 108 and extends substantially in a normal direction relative to the beam axis X. Specifically, since the front steering beam 108 is generally straight and linear in the illustrated embodiment, the front beam pivot axis P₁ is generally perpendicular or orthogonal to the beam axis X. Still in the illustrated embodiment, since the left and right wheel axes W₁, W₂ are parallel to the beam axis X, the front beam pivot axis P₁ is therefore also generally perpendicular or orthogonal to the left and right wheel axes W₁, W₂.

Alternatively, the left and right wheel axes W₁, W₂ may not be parallel to each other. Instead, the left and right front wheels 114, 116 could be oriented at a positive or negative camber angle relative to the vehicle frame 52, which would cause the left and right wheel axes W₁, W₂ to be angled upwardly or downwardly when viewed in an elevation view (i.e. from the front or the rear of the vehicle).

Still in the illustrated embodiment, the front beam pivot axis P₁ is also substantially centered between the left and right ends 110, 112 of the steering beam 108. Alternatively, the front beam pivot axis P₁ could be offset towards one of the left and right ends 110, 112 of the front beam pivot axis P₁.

It will be understood that the pivot axle is only allowed to rotate about its axis (i.e. the front beam pivot axis P₁), and that other movements of pivot axle are prevented by the configuration of the front bracket 106 and/or of the front steering beam 108. Specifically, in contrast with a wheel axle found in most conventional vehicle steering systems, the steering beam 108 does not rotate about its beam axis X.

Instead, only the left and right front wheels 114, 116 rotate relative to the steering beam 108, and therefore are allowed to rotate independently from each other.

In the embodiment illustrated in FIGS. 1-4, the front beam pivot axis P₁ is not vertical, but is instead angled relative to a vertical axis V (i.e. an axis which extends orthogonally or normally to a ground surface 250 on which the vehicle 50 is travelling) at a front pivot angle θ₁, as best shown in FIG. 2. In this configuration, the front beam pivot axis P₁ is therefore not orthogonal to the ground surface 250, but is instead angled relative to both the vertical axis V and the ground surface 250 at an angle different than 90 degrees when the vehicle 50 is viewed from the side. More specifically, the front beam pivot axis P₁ is angled such that it slopes down from the front end 54 towards the rear end 56 of the vehicle frame 52.

It will be understood that the left and right front wheels 114, 116 are adapted to contact the ground surface 250 and that the front steering beam 108, which extends between the left and right front wheels 114, 116 and more specifically between a center of the left and right front wheels 114, 116, is thereby spaced upwardly above the ground surface 250. In the illustrated embodiment, the left and right front wheels 114, 116 have the same diameter and therefore the left and right ends 110, 112 of the front steering beam 108 are both located in a common beam plane B which is located above the ground surface 250 and which extends parallel to the ground surface 250. It will further be understood that when the steering beam 108 is pivoted, the left and right front wheels 114, 116 remain in contact with the ground surface 250. Therefore, the left and right ends 110, 112 of the front steering beam 108 are constrained to the beam plane B and remain in the beam plane B when the steering beam 108 is pivoted, such that the entire pivoting movement of the front steering beam 108 occurs generally in or within the beam plane B.

In the illustrated embodiment, each front wheel 114, 116 is individually powered. Specifically, the left front wheel 114 is operatively connected to a left wheel motor 118 mounted to the front steering beam 108 and the right front wheel 116 is connected to a right wheel motor 120, also mounted to the front steering beam 108. Both the left and right wheel motors 118, 120 are further operatively connected to a controller 122 which is configured to allow a rotation speed of the left front wheel 114 and a rotation speed of the right front wheel 116 to be adjusted individually. Specifically, the controller 122 allows the left wheel motor 118 to rotate the left front wheel 114 at a first rotation speed and the right wheel motor 120 to rotate the right front wheel 116 at a second rotation speed which is different from the first rotation speed, thereby creating a speed differential which causes the vehicle 50 to make a turn.

To deviate from the normal forward travel direction A and thereby cause the vehicle 50 to make a turn in a desired turn direction, the rotation speed of the front wheel 114 or 116 located opposite the turn direction is adjusted to a speed greater than the rotation speed of the front wheel 114 or 116 located towards the turn direction. For example, if a user of the vehicle wishes to make a right turn, the rotation speed of the left front wheel 114 would be adjusted by the controller 122 to be greater than the rotation speed of the right front wheel 116. Similarly, if the user wishes to make a left turn, the rotation speed of the right front wheel 116 would be adjusted by the controller 122 to be greater than the rotation speed of the left front wheel 114.

Still referring to FIGS. 1-4, the rear steering subassembly 104 is generally similar to the front steering assembly 102 and includes a rear bracket 130 extending rearwardly from the rear end 56 of the vehicle frame 52 and a rear steering beam 132 pivotably mounted to the rear bracket 130 to allow the rear steering beam 132 to pivot about a rear beam pivot axis P₂. Similarly to the front beam pivot axis P₁, the rear beam pivot axis P₂ is also angled relative to the vertical axis V at a rear pivot angle θ₂, as best shown in FIG. 2. Specifically, the rear beam pivot axis P₂ is angled such that it slopes down from the rear end 56 towards the front end 54 of the vehicle frame 52. When viewed in a side elevation view, as shown in FIG. 2, the front and rear beam pivot axes P₁, P₂ therefore converge towards each other as they extend downwardly. In the illustrated embodiment, the front and rear beam pivot axes P₁, P₂ are further mirror images of each other, such that the front pivot angle θ₁ and the rear pivot angle θ₂ are substantially equal to each other but inverted relative to each other. In the illustrated embodiment, both the front pivot angle θ₁ and the rear pivot angle θ₂ are between about 0 degrees and 45 degrees, and more specifically about 15 degrees. It will be appreciated that alternatively, the front and rear beam pivot axes P₁, P₂ could be angled at front and rear pivot angles θ₁, θ₂ having different values than those disclosed above.

Furthermore, although the front pivot angle θ₁ and the rear pivot angle θ₂ are shown as being identical (although inverted relative to each other) in the embodiment illustrated in FIGS. 1-4, the front and rear beam pivot axes P₁, P₂ could instead be angled at front and rear pivot angles θ₁, θ₂ which are different from each other.

Also similarly to the front steering subassembly 102, the rear steering subassembly 104 also includes left and right rear wheels 134, 136 which are rotatably mounted to the rear steering beam 132 and which are operatively connected to left and right rear wheel motors 138, 140. In this embodiment, the left and right rear wheel motors 138, 140 are operatively connected to the controller 122 which can adjust the rotation speed of the left and right rear wheels 134, 136 independently from each other.

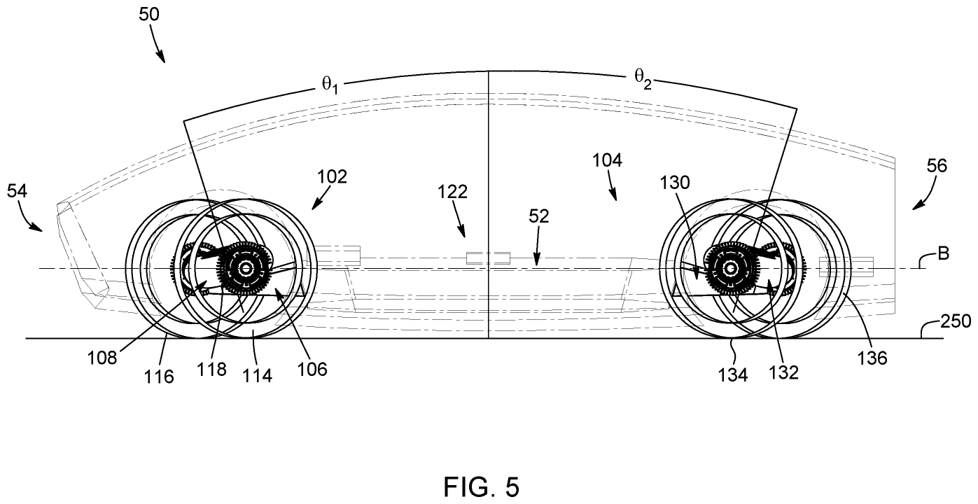

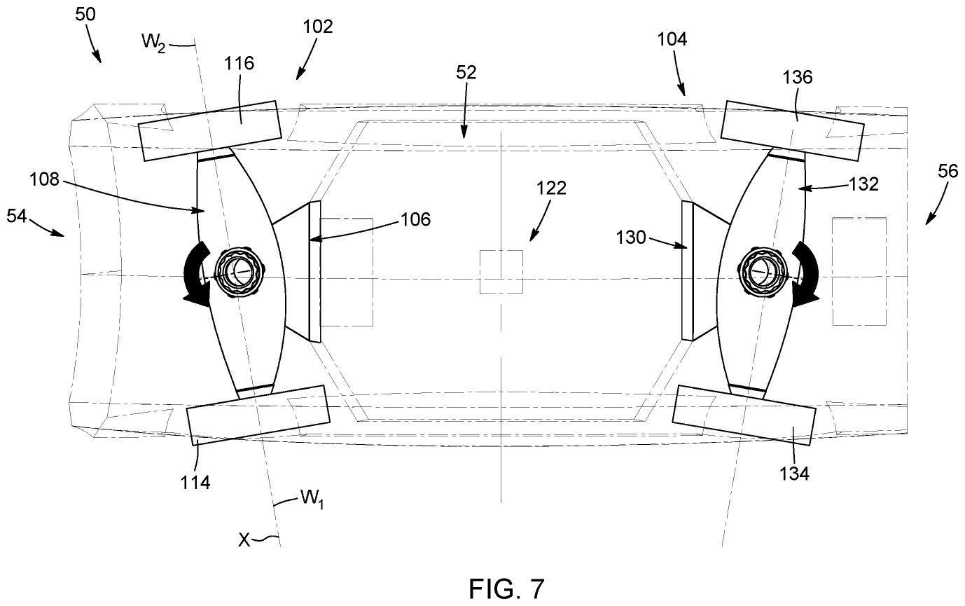

Referring now to FIGS. 5-7, when the vehicle 50 is travelling forward in the normal forward travel direction A and the user wishes to make a left turn, for example, a command is provided to the controller 122, which simultaneously adjust the speeds of the vehicle's wheels 114, 116, 134, 136 such that the left front wheel 114 has a rotation speed which is lower than a rotation speed of the right front wheel 116 and the right rear wheel 136 has a rotation speed which is lower than the left rear wheel 134. When seen from above, the front steering beam 108 will therefore generally pivot about the front beam pivot axis P₁ in a counterclockwise direction and the rear steering beam will generally pivot about the rear beam pivot axis P₂ in a clockwise direction, as shown in FIG. 7.

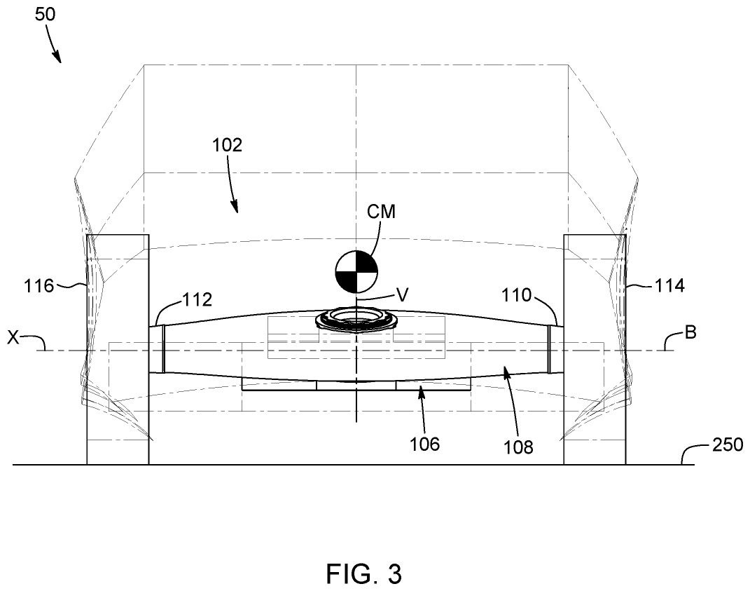

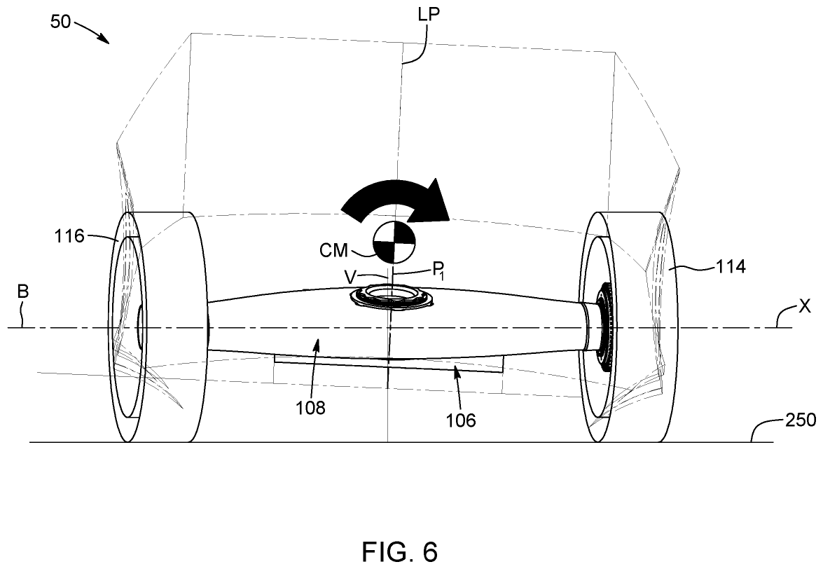

Furthermore, the front and rear beam pivots axes P₁, P₂ are generally centered transversely between the left and right sides of the vehicle 50 when the vehicle is travelling in the normal forward travel direction A. Specifically, the vehicle frame 104 defines a median longitudinal plane LP which, when the vehicle is travelling in the normal forward travel direction A, is generally orthogonal to the ground surface 250, and both the front and rear beam pivots axes P₁, P₂ extend in the median longitudinal plane LP, as shown in FIG. 3. When turning, due to the front and rear beam pivots axes P₁, P₂ being angled relative to the vertical, the pivoting of the steering beams will cause the beam pivots axes P₁, P₂ to also become angled relative to the vertical axis V towards the turning direction when the vehicle 50 is viewed from the front, as best shown in FIG. 6. This will have the effect of tilting the entire vehicle 50 towards the turning direction.

This tilting or “roll” of the vehicle 50 about a longitudinal roll axis of the vehicle will also cause a lateral shift in the mass of the vehicle 50. More specifically, the mass of the frame 52 itself and of everything supported on the frame 52, including other subsystems of the vehicle, passengers and/or cargo, is usually referred to in the art as the “sprung mass” or “sprung weight” of the vehicle 50. When the vehicle 50 is travelling in the normal forward travel direction A, it is generally located within the median longitudinal plane LP of the vehicle 50 and the median longitudinal plane LP is generally aligned with the vertical axis V, as shown in FIG. 3.

It will be appreciated that in most vehicles, centrifugal acceleration will tend to pull the sprung mass of the vehicle away from the turning direction. This may reduce the adhesion of the vehicle's wheel to the ground surface on which the vehicle travels.

In the present vehicle 50, when the beam pivot axes P₁, P₂ become angled relative to the vertical axis V when viewing the vehicle 50 from the front and the vehicle 50 is tilted towards the turning direction, as shown in FIG. 6, the median longitudinal plane LP also becomes angled relative to the vertical axis V and the center of mass CM of the sprung weight will tend to shift from the vertical inwardly into the turn, instead of away from the turning direction.

By shifting the center of mass CM inwardly as the vehicle 50 turns, the steering assembly 100 described herein therefore counteracts this overturning moment and enhances the adhesion capacity of the vehicle 50 when the vehicle 50 turns.

It will be understood that when the user is travelling forward and wishes to make a right turn instead of a left turn, the controller 122 configures the front and rear steering subassemblies 102, 104 in the exact opposite of the configuration described above. This will cause the front steering beam 108 to generally pivot about the front beam pivot axis P₁ in a clockwise direction and the rear steering beam 132 to generally pivot about the rear beam pivot axis P₂ in a counterclockwise direction. All other effects described above will be mirrored on the other side of the vehicle 50.

In another embodiment, the controller 122 could be configured to adjust the rotation speed of the wheels 114, 116, 134, 136 according to one of various other schemes.

Alternatively, the front beam pivot axis P₁ and the rear beam pivot axis P₂ could be substantially vertical, instead of being angled relative to the vertical axis V. In this configuration, the front and rear beam pivot axes P₁, P₂ would therefore be substantially orthogonal to a ground surface on which the vehicle 50 travels. In this embodiment, the center of mass CM may therefore not shift inwardly in the turn direction as the vehicle 50 turns.

Furthermore, in the embodiment illustrated in FIGS. 5-7, the rotation speed of all four wheels 114, 116, 134, 136 of the vehicle 50 is adjusted when making a turn, as described above. In another embodiment, the steering assembly 100 may only include a front steering subassembly 102. Instead of having a rear steering subassembly 104, the steering assembly 100 may include an unpowered, passive rear wheel assembly, which may include a single wheel or more than one wheels. In an embodiment in which the front beam pivot axis P₁ is substantially vertical, the steering assembly 100 may simply include one or more static wheels which would be positioned at the rear end of the vehicle frame and which cannot be pivoted.

In yet another embodiment, instead of having a front steering subassembly 102, the steering assembly 100 may include an unpowered, passive front wheel assembly, which may include a single wheel or more than one wheels. In an embodiment in which the rear beam pivot axis P₂ is substantially vertical, the steering assembly 100 may simply include one or more static wheels which would be positioned at the front end of the vehicle frame and which cannot be pivoted.

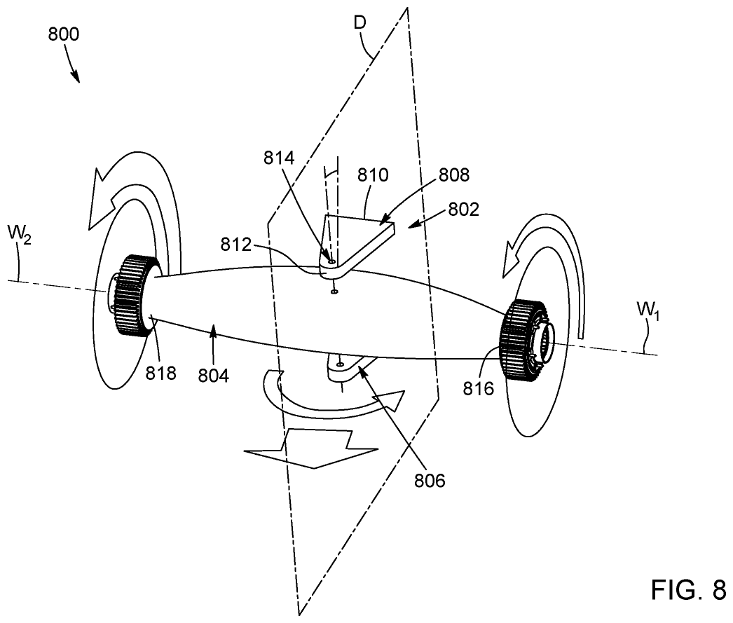

Now referring to FIG. 8, there is shown a front steering subassembly 800 for steering assembly 100, in accordance with one embodiment.

In the embodiment illustrated in FIG. 8, the front steering subassembly 800 includes a bracket 802 which is adapted to be secured to the vehicle frame 52 and a steering beam 804 adapted to be pivotably connected to the bracket 802 via a pivot axle, not shown. Specifically, instead of including a single bracket element such as the bracket 106 illustrated in FIGS. 1-7 which is disposed above or below the steering beam 804, the bracket 802 includes a lower bracket plate 806 and an upper bracket plate 808 disposed generally above the lower bracket plate 806. The lower and upper bracket plates 806, 808 extend generally parallel to each other and are spaced from each other to receive the steering beam 804.

Still in the embodiment illustrated in FIG. 8, the lower and upper bracket plates 806, 808 are generally triangular and include a base edge 810 adapted to be secured to the vehicle frame 52, a rounded corner 812 located opposite the base edge 810 and an axle receiving bore 814 for receiving a respective one of a lower end and an upper end of the pivot axle.

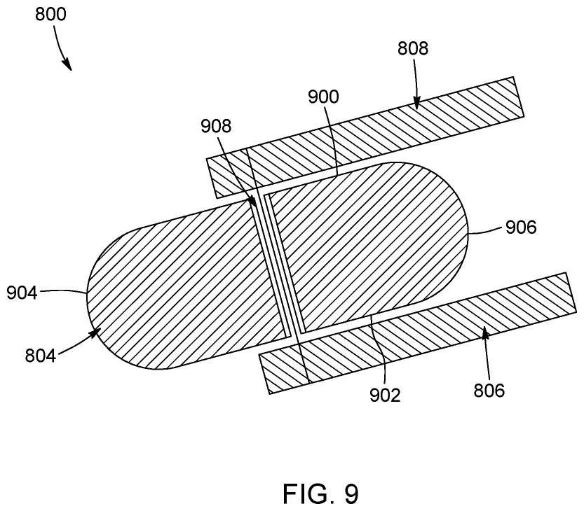

Alternatively, instead of being generally triangular, the lower and upper bracket plates 806, 808 could have any other shape which a skilled person may consider to be suitable. Furthermore, although the lower and upper bracket plates 806, 808 illustrated in FIGS. 8 and 9 have the same shape, the lower bracket plate 806 could instead have a different shape than the upper bracket plate 808.

Still referring to FIGS. 8 and 9, the steering beam 804 has a left end 816 adapted to be located towards the left of the vehicle 50 and a right end 818 adapted to be located towards the right of the vehicle 50. In this embodiment, the steering beam 804 is generally football-shaped and bulges at a center of the steering beam 804. The steering beam 804 may further be relatively resilient or compliant to be deformable in bending in a plane which would extend vertically and transversely to the vehicle, such that the steering beam 804 may act as a spring or a shock absorber.

As best shown in FIG. 9, the steering beam 804 further has a generally flat and oblong cross-section defined by planar top and bottom faces 900, 902 which extend parallel to each other and are connected by front and rear convex faces 904, 906. The steering beam 804 further includes an axle receiving bore 908 which extends through the steering beam 804, near the center of the steering beam 804, between the planar top and bottom faces 900, 902. As further shown in FIG. 9, the axle receiving bore 908 also extend generally perpendicularly to the top and bottom faces 900, 902.

In this embodiment, the pivot axle, not shown, extends through the axle receiving bores 814, not shown in FIG. 9, of the lower and upper bracket plates 806, 808 and through the axle receiving bore 908 of the steering beam 804.

The pivot axle may be maintained in this position in a clevis-type arrangement such that the pivot axle may rotate about the pivot axis P₁ relative to both the bracket 802 and the steering beam 804. In another embodiment, the pivot axle may be secured to the bracket 802 and only be rotatable relative to the steering beam 804. In yet another embodiment, the pivot axle may instead be secured to the steering beam 804 and be rotatable only relative to the bracket 802.

It will be understood that the connection between the pivot axle and the steering beam 804 is not limited to the configuration described above and that various alternative configuration may be used. For example, instead of providing the pivot axle as a distinct piece, the pivot axle could instead include a top pin and a bottom pin secured to the top and bottom faces of the steering beam 804 and engaging the axle receiving bores 814 of the lower and upper bracket plates 806, 808.

In yet another embodiment, the bracket 802 may only include an upper bracket plate or only a lower bracket plate instead of including both upper and lower bracket plates. The bracket 802 may also have one of various alternative shape and/or configuration which a skilled person would consider suitable to receive the steering beam and allow the steering beam to pivot relative to the vehicle frame 52.

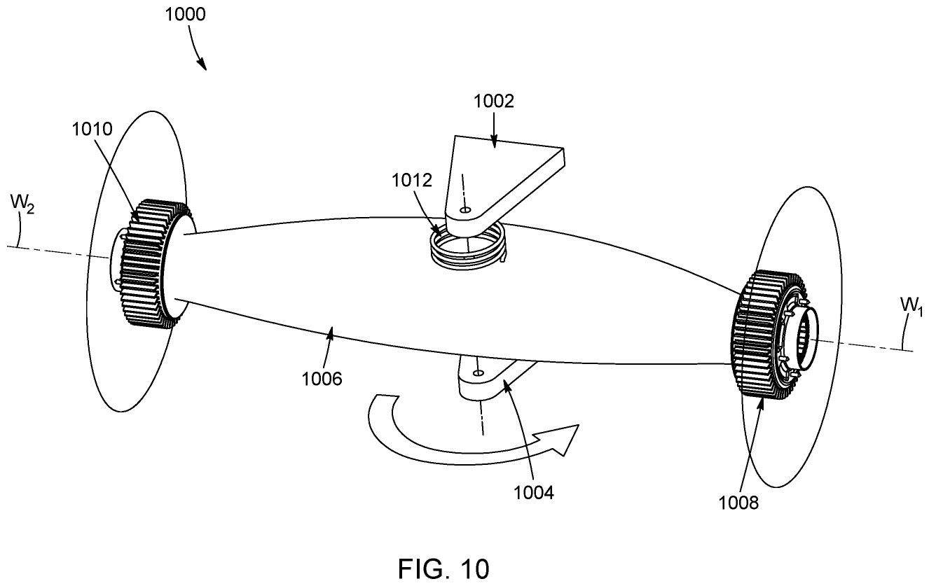

Now turning to FIG. 10, there is shown a front steering subassembly 1000 for the steering assembly 100, in accordance with another embodiment.

The front steering subassembly 1000 is generally similar to the front steering subassembly 800 illustrated in FIGS. 8 and 9 and described above, and includes upper and lower bracket plates 1002, 1004 adapted to be secured to the frame of the vehicle, a steering beam 1006 pivotably mounted to the bracket plates 1002, 1004 via a pivot axle, not shown, and left and right motors 1008, 1010 rotatably mounted to the steering beam 1006.

In the embodiment illustrated in FIG. 10, the front steering subassembly 1000 further includes a resilient element such as a torsion spring 1012 which is concentrically mounted around the pivot axle to urge the steering beam 1006 back to a predetermined orientation such as a forward orientation when the steering beam 1006 has been pivoted away from the predetermined orientation. This facilitates returning to a forward travel along the normal forward travel direction A after the vehicle has made a turn.

In the illustrated embodiment, the torsion spring 1012 is further disposed between the steering beam 1006 and the upper bracket plate 1002. Alternatively, the torsion spring 1012 could instead be elsewhere, such as between the steering beam 1006 and the lower bracket plate 1004. In yet another embodiment, the front steering subassembly 1000 could include two or more torsion springs concentrically mounted around the pivot axle.

In still another embodiment, instead of a torsion spring, the front steering subassembly 1000 could include an elastomeric ring or any other similar device having resilient properties.

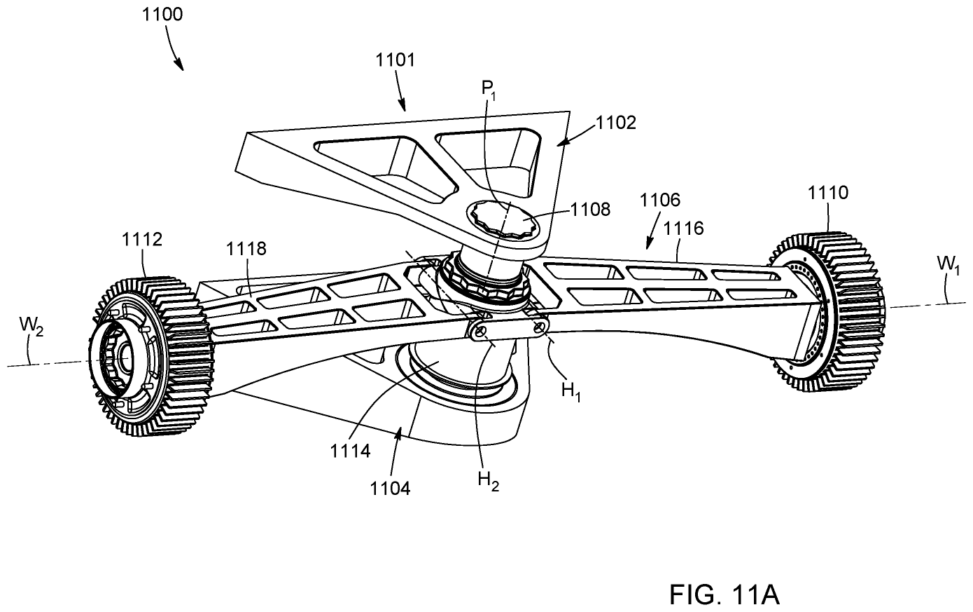

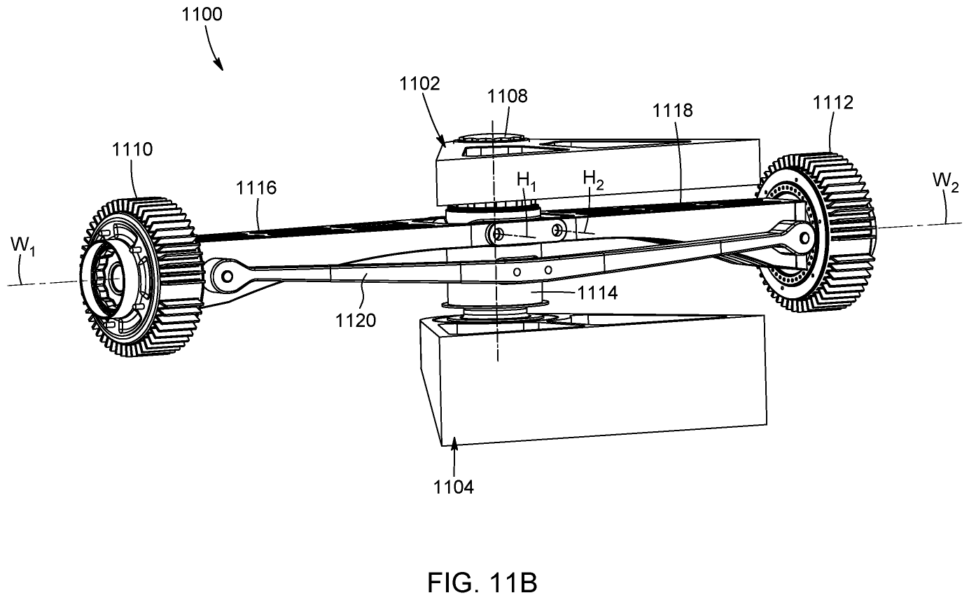

Referring now to FIGS. 11A and 11B, there is shown a front steering subassembly 1100, in accordance with yet another embodiment.

The front steering subassembly 1100 comprises a bracket 1101 which includes upper and lower bracket plates 1102, 1104 adapted to be secured to the vehicle frame, a steering beam 1106 pivotably connected to the bracket plates 1102, 1104 via a pivot axle 1108 and left and right wheel motors 1110, 1112 rotatably mounted to the steering beam 1106.

In this embodiment, the steering beam 1106 includes a central cylindrical hub or sleeve 1114 sized and shaped to receive the pivot axle 1108, and left and right steering arms 1116, 1118 hingeably connected to the central sleeve 1114. Specifically, the left steering arm 1116 is movable relative to the central sleeve 1114 about a generally horizontal left hinge axis H₁ and the right steering arm 1118 is movable relative to the central sleeve 1114 about a generally horizontal right hinge axis H₂ which is parallel to the left hinge axis H₁.

The front steering subassembly 1100 further comprises a leaf spring member 1120 which resiliently connects together the left and right steering arms 1116, 1118 to the central sleeve 1114. The leaf spring member 1120 substantially maintains the left and right steering arms 1116, 1118 in a predetermined position (such as generally within a common plane, for instance), and urges the left and right steering arms 1116, 1118 back towards the predetermined position when the left and/or right steering arm 1116, 1118 is moved away from the predetermined position. In this configuration, the leaf spring member 1120 could therefore form at least part of a suspension system of the vehicle.

In the embodiment illustrated in FIGS. 11A and 11B, the bracket plates 1102, 1104 and the steering beam 1106 could be manufactured using a plastic material, and more specifically using a fibre-reinforced plastic material. Alternatively, the bracket plates 1102, 1104 and the steering beam 1106 could be manufactured using any material that a skilled person would consider to be suitable.

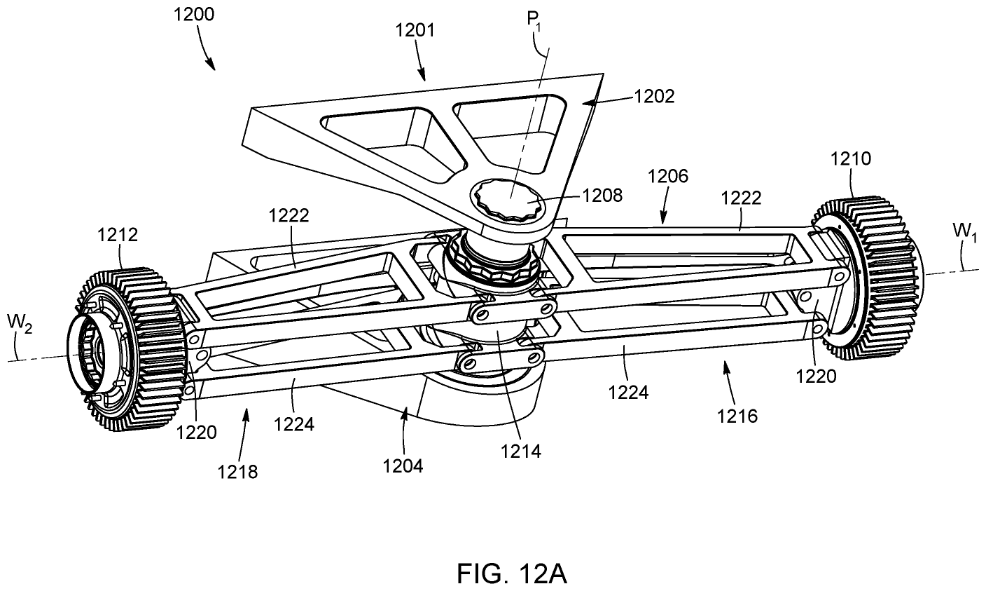

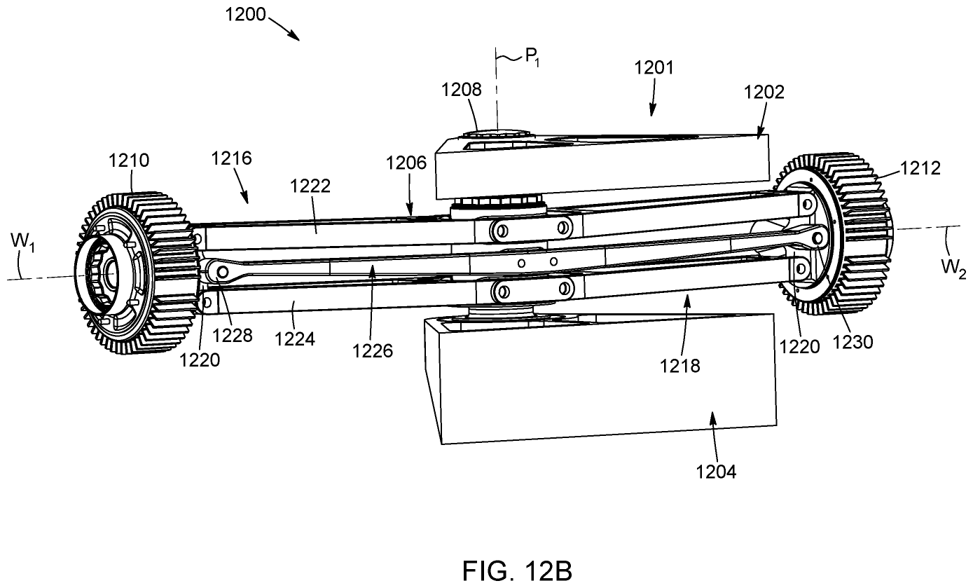

Referring now to FIGS. 12A and 12B, there is shown a front steering subassembly 1200, in accordance with yet another embodiment.

The front steering subassembly 1200 is generally similar to the front steering subassembly 1100 illustrated in FIGS. 11A and 11B. More specifically, the front steering subassembly 1200 comprises a bracket 1201 which includes upper and lower bracket plates 1202, 1204 adapted to be secured to the vehicle frame, a steering beam 1206 pivotably connected to the bracket plates 1202, 1204 via a pivot axle 1208 and left and right wheel motors 1210, 1212 rotatably mounted to the steering beam 1206. Also similarly to the front steering assembly 1100 illustrated in FIGS. 11A and 11B, the front steering subassembly 1200 includes a central cylindrical hub or sleeve 1214 sized and shaped to receive the pivot axle 1208, and left and right steering arms 1216, 1218 hingeably connected to the central sleeve 1214.

In the embodiment illustrated in FIGS. 12A and 12B, each steering arm 1216, 1218 does not include a single, monolithic element, but instead includes multiple elements assembled together. More specifically, each steering arm 1216, 1218 includes a wheel mounting body 1220 disposed away from the central sleeve 1214 and upper and lower arm members 1222, 1224 which extend between the central sleeve 1214 and the wheel mounting body 1220. The wheel mounted body 1220 is sized and shaped to receive a corresponding wheel motor 1210, 1212 which operatively engages a corresponding wheel, not shown. The upper and lower arm members 1222, 1224 extend generally parallel to each other and are hingeably connected to both the central sleeve 1214 and the wheel mounting body 1220 to thereby define a four-bar linkage arrangement between the central sleeve 1214 and the wheel mounting body 1220. The wheel mounting body 1220 is configured to engage the corresponding wheel such that the wheel rotates about the corresponding wheel axis W₁, W₂, which extends substantially orthogonally to the beam pivot axis P₁ extending through the pivot axle 1208, and as the wheel mounting body 1220 moves generally upwardly or downwardly relative to the central sleeve 1214, the wheel axis W₁, W₂ remains substantially orthogonal to the beam pivot axis P₁.

Alternatively, each wheel may be oriented at a positive or negative camber angle such that the corresponding wheel axis W₁, W₂ does not extend orthogonally to the beam pivot axis P₁, but instead is angled at a camber angle relative to the beam pivot axis P₁. In this embodiment, the four-bar linkage arrangement causes the wheel axis W₁, W₂ to remain substantially angled at the camber angle relative to the beam pivot axis P₁ as the wheel mounting body 1220 moves generally upwardly or downwardly relative to the central sleeve 1214.

In the embodiment illustrated in FIGS. 12A and 12B, the front steering subassembly 1200 further comprises a leaf spring member 1226 which resiliently connects the left and right steering arms 1216, 1218 together and to the central sleeve 1214. The leaf spring member 1226 is generally similar to the leaf spring member 1120 illustrated in FIGS. 11A and 11B and substantially maintains the left and right steering arms 1216, 1218 in a predetermined position and urges the left and right steering arms 1216, 1218 back towards the predetermined position when the left and/or right steering arm 1216, 1218 is moved away from the predetermined position. More specifically, the leaf spring member 1226 includes a left end 1228 connected to the wheel mounting body 1220 of the left steering arm 1216 and a right end 1230 connected to the wheel mounting body 1220 of the right steering arm 1218. Alternatively, the leaf spring member 1226 could instead be connected to the upper and/or lower arm members 1222, 1224 of the left and right steering arms 1216, 1218.

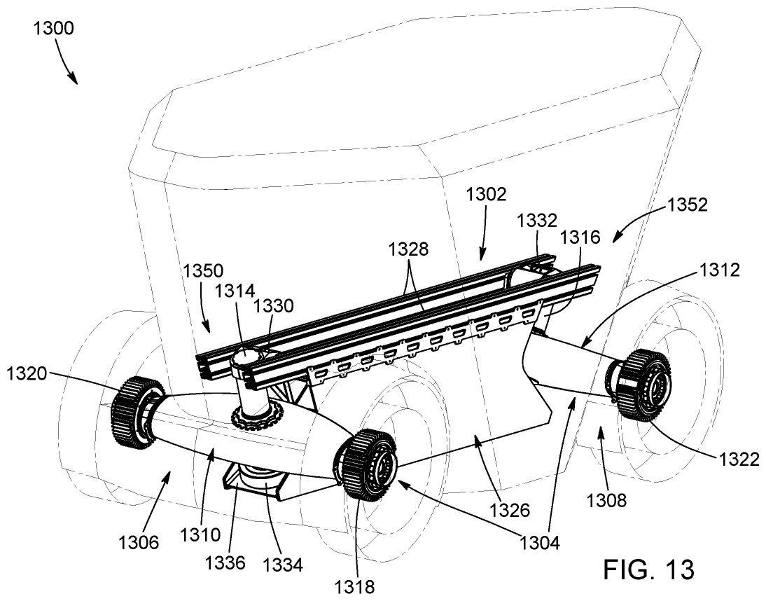

Turning to FIG. 13, there is shown a vehicle 1300, in accordance with another embodiment. The vehicle 1300 includes a vehicle frame 1302 and a steering assembly 1304 operatively connected to the frame 1302. Specifically, the steering assembly 1304 includes a front steering subassembly 1306 connected to a front end 1350 of the vehicle frame 1302 and a rear steering subassembly 1308 connected to a rear end 1352 of the vehicle frame 1302. The front and rear steering subassemblies 1306, 1308 are generally similar to the front and rear steering subassemblies 102, 104 described in FIGS. 1-7 above and include front and rear steering beams 1310, 1312 pivotable about front and rear pivot axles 1314, 1316, respectively, and motors 1318, 1320, 1322 secured to the steering beams 1310, 1312.

In the illustrated embodiment, the vehicle frame 1302 includes an elongated hollow body 1326 defining an internal storage compartment, not shown, and a pair of parallel frame beams 1328 extending longitudinally relative to the vehicle 1300 and secured on the hollow body 1326. The frame beams 1328 are spaced apart to receive front and rear collars 1330, 1332 which are sized and shaped to rotatably receive the front and rear pivot axles 1314, 1316. Each pivot axle 1314, 1316 is further received in a bearing 1334 which is disposed on an angled, upward-facing surface 1336 of the hollow body 1326. The corresponding collar 1330 or 1332 is also angled to orient the pivot axle 1314, 1306 at an angle and thereby allow the front and rear steering beams 1310, 1312 to pivot about pivot axes which are angled relative to the vertical.

As shown in FIG. 13, in this configuration, the internal storage compartment is therefore generally horizontally aligned (i.e. on a same horizontal plane) as the front and rear steering beams 1310, 1312. It will be appreciated that storing subsystems of the vehicle, including an energy source such as batteries, a combustion engine or the like, and/or cargo in the hollow body 1326 may lower the center of mass of the vehicle 1300 and thereby increase the stability of the vehicle 1300.

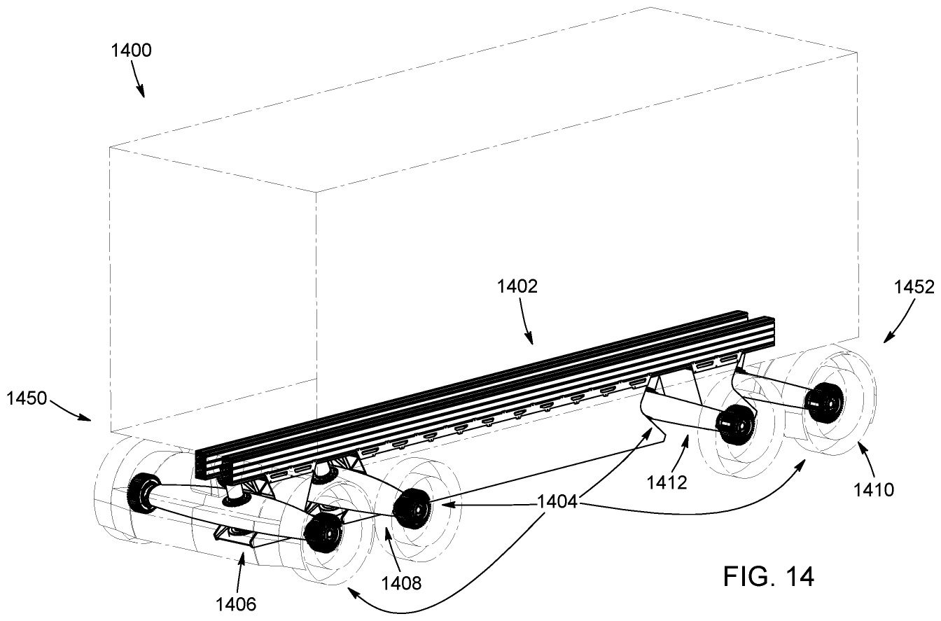

Turning now to FIG. 14, there is shown a vehicle 1400, in accordance with yet another embodiment. The vehicle 1400 is generally similar to the vehicle 1300 illustrated in FIG. 13 and described above, and includes a vehicle frame 1402 and a steering assembly 1404 operatively connected to the vehicle frame 1402. In this embodiment, the steering assembly 1404 includes a first front steering subassembly 1406 located towards a front end 1450 of the vehicle frame 1402, a second front steering subassembly 1408 also located towards the front end of the vehicle frame 1402 but rearwardly of the first front steering subassembly 1406, a first rear steering subassembly 1410 located towards a rear end 1452 of the vehicle frame 1402 and a second rear steering assembly 1412 also located towards the front end of the vehicle frame 1402 but forward of the first rear steering subassembly 1410. Each steering subassembly is generally similar to the front and rear steering subassemblies 1306, 1308 described above in relation to FIG. 13.

In this embodiment, all of the wheels could be powered and steered as described above. This could provide greater locomotive power to the vehicle, both when travelling along the normal forward direction and during turns, which may be particularly beneficial when the vehicle is transporting heavy cargo. Alternatively, only some of the wheels could be powered and steered as described above. In yet another embodiment, the steering assembly 1404 could include more than two front steering subassemblies and/or more than two rear steering subassemblies.

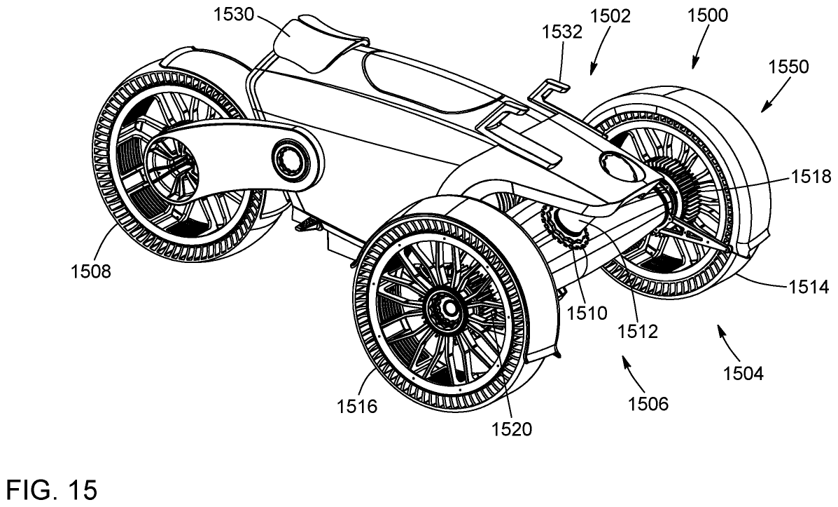

Referring to FIG. 15, there is shown a vehicle 1500, in accordance with yet another embodiment. In this embodiment, the vehicle 1500 includes a vehicle frame 1502 and a steering assembly 1504 operatively connected to the vehicle frame 1502. In this embodiment, the steering assembly 1504 includes a front steering subassembly 1506 located towards a front end 1550 of the vehicle frame 1502, but does not include a rear steering assembly. Instead, the vehicle 1500 includes a single rear wheel 1508 which does not pivot relative to the vehicle frame 1502.

The front steering subassembly 1506 is similar to the front steering subassembly 102 illustrated in FIGS. 1-4 and includes a steering beam 1510 pivotably connected to the vehicle frame 1502 via a kingpin or pivot axle 1512 and left and right front wheels 1514, 1516 rotatably connected to the steering beam 1510. Also similarly to the front steering subassembly 102 illustrated in FIGS. 1-4, the pivot axle 1512 extends along a pivot axis of the steering beam 1510 which is angled relative to the vertical, as shown in FIG. 15.

In this embodiment, the left and right front wheels 1514, 1516 are respectively operatively connected to left and right front motors 1518, 1520 which are mounted to the steering beam 1510. The left and right front motors 1518, 1520 are further operatively connected to a controller, not show, which is configured to allow the rotation speed of the left and right front wheels 1514, 1516 to be adjusted individually. The rear wheel 1508 could be similarly powered by a rear motor controlled independently from the left and right front motors 1518, 1520 or could be entirely unpowered.

In the embodiment illustrated in FIG. 15, the vehicle 1500 further includes a seat 1530 which is secured on top of the vehicle frame 1502 for receiving a user and a steering interface 1532 which is also secured on top of the vehicle frame 1502, towards the front end 1550 of the vehicle frame 1502. Specifically, the seat 1530 and the steering interface 1532 are positioned such that the user sitting on the seat 1530 leans forwardly and generally straddles the vehicle frame 1502 while operating the vehicle 1500, as if on a motorcycle or an all-terrain vehicle (or ATV).

To make a turn, a command may be sent to the controller to adjust the rotation speed of at least one of the left and right front wheels 1514, 1516 such that the rotation speed of the front wheel 1514 or 1516 located opposite the turn direction is greater than the rotation speed of the front wheel 1514 or 1516 located towards the turn direction.

It will be appreciated that the above embodiments are merely provided as examples and that various alternative embodiments may be conceived.

It will further be appreciated that the motors illustrated in FIGS. 1-15 and described above include wheel hub motors, which are relatively compact and can be mounted relatively easily on the steering beam, in the hubs of the wheels. Alternatively, the motors could include geared motors which each include a transmission assembly which is operatively connected to the wheel to allow power from the motor to be transmitted to the corresponding wheel.

In another embodiment, two or more wheels could be operatively coupled to a single motor, each one through an individual transmission assembly which could be operatively connected to the controller such that the controller may adjust the rotation speed of the wheel by adjusting the corresponding transmission assembly rather than controlling the motor speed, or by a combination of controlling the motor speed and adjusting the corresponding transmission assembly.

Furthermore, although the controller 122 has been shown in FIGS. 1-15 and in the above description as being mounted on the vehicle frame, it will be understood that the controller could instead be remote from the vehicle and could be configured to wirelessly send commands to and/or receive data from one or more communication units mounted on the vehicle frame. It will also be appreciated that the controller 122 could include a plurality of components such as a central processing unit or CPU, one or more drives operatively connected to the CPU, each drive being operatively coupled to one of the motors to control the rotation speed of the motor, a memory, or any other components which a skilled person would consider to be suitable for controlling the steering assembly.

It will further be appreciated that by providing individual motors, each one associated with one of the wheels, and by allowing the motors to be controlled individually by the controller, the steering assembly described above can also be used to assist or even replace other subsystems of the vehicle. For example, a vehicle which includes the steering assembly may not need a separate braking subsystem. Instead, when the user wishes to reduce the forward travelling speed of the vehicle or to stop the vehicle from moving, he may simply send a command to the controller to simultaneously reduce rotation speed or stop rotation of all or some of the wheels.

In another example, the controller could be configured to modulate the rotation speed of the wheels according to a frequency or a range of frequencies of vibrations in the wheels and/or in the vehicle frame. This configuration would allow the steering assembly to damp at least a portion of the vibrations from the vehicle as the vehicle is travelling on the ground surface to thereby assist a shock absorbing subsystem of the vehicle, or even to eliminate entirely the need for a shock absorbing subsystem. More specifically, the vehicle may include a vibration sensor operatively connected to at least one of a corresponding wheel and the vehicle frame. The vibration sensor is further operatively connected to the controller and is configured for measuring vibrations in the one of the corresponding wheel and the frame, and the controller is configured for determining a frequency of the vibrations based on the measured vibrations over a period of time.

To damp vibrations using this configuration, vibrations would first be measured using the vibration sensor over a period of time and a vibration frequency would be determined by the controller. The rotation speed of some or all of the wheels would then be modulated by the controller according to the determined vibration frequency. For example, the rotation speed could be modulated according to a speed modulation pattern associated with this determined vibration frequency. Alternatively, the controller could determine that the determined vibration frequency is within a predetermined vibration frequency range and could modulate the rotation speed of some or all of the wheels according to a speed modulation pattern associated with this predetermined vibration frequency range.

It will be appreciated that the steering assembly described above therefore provides a method for controlling motion of a vehicle travelling on a ground surface. Specifically, controlling motion of the vehicle includes braking, steering and/or absorbing shocks in a vehicle using a single subsystem (i.e. the steering system) including a plurality of wheels, a plurality of motor, each motor being operatively coupled to a corresponding wheel, and a controller operatively connected to the motors to allows the rotation speed of the motors to be adjusted individually.

For example, the method could first include providing a steering assembly for the vehicle. The steering assembly includes a steering beam being pivotably connected to a vehicle frame of the vehicle and left and right wheels rotatably mounted respectively to left and right ends of the steering beam. More specifically, the left and right wheels are rotatable relative to the steering beam respectively about left and right wheel axes. Furthermore, the left and right wheels also maintain the left and right ends of the steering beam in a beam plane parallel to the ground surface.

It will be understood that the steering assembly could include any of the steering assemblies 100, 1100, 1304, 1404, 1412, 1504, 100′ described above, and could therefore also include any of the features described above in connection with these steering assemblies.

The method could further include adjusting a rotation speed of the left wheel to a first rotation speed, and further adjusting a rotation speed of the right wheel to a second rotation speed different from the first speed. This causes the steering beam to pivot relative to the vehicle frame about a beam pivot axis which extends through the steering beam such that the left and right ends of the steering beam move around the beam pivot axis while remaining within the beam plane.

To further control motion of the vehicle, the method could further comprise reducing the rotation speed of the left wheel and simultaneously reducing the rotation speed of the right wheel to thereby cause the vehicle to brake. It will be understood that the term “brake” refer to the reduction of the forward or rearward travelling speed or turning speed of the vehicle, which may or may not bring the vehicle to a complete stop.

To further control motion of the vehicle, the method could further comprise, using a vibration sensor, measuring vibrations in at least one of the left and right wheels and the vehicle frame over a period of time. The method could then comprise determining a vibration frequency of the vibrations based on the measured vibrations, and modulating the rotation speed of at least one of the left and right wheels according to the determined vibration frequency to thereby damp vibrations in the at least one of the left and right wheels and the vehicle frame as described above.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A steering assembly for a vehicle, the vehicle including a vehicle frame having a front end and a rear end, the steering assembly comprising:
a steering beam having a left end and a right end, the steering beam being pivotably connectable to the vehicle frame such that the left end is located towards a left side of the vehicle and the right end is located towards a right side of the vehicle, the steering beam being configured to pivot relative to the vehicle frame about a beam pivot axis located between the first and second ends of the steering beam and extending through the steering beam;
left and right wheels rotatably connected to the steering beam respectively at the left and right ends thereof, the left and right wheels being rotatable relative to the steering beam respectively about left and right wheel axes extending away from the steering beam, the left and right wheels maintaining the left and right ends of the steering beam in a beam plane parallel to the ground surface when the left and right wheels contact the ground surface such that, when the steering beam is pivoted, the left and right ends of the steering beam move around the beam pivot axis while remaining within the beam plane;
a left wheel motor secured to the steering beam at the left end thereof, the left wheel motor being operatively connected to the left wheel for rotating the left wheel;
a right wheel motor secured to the steering beam at the right end thereof, the right wheel motor being operatively connected to the right wheel for rotating the right wheel;
a controller operatively connected to the left wheel motor and to the right wheel motor for controlling a rotation speed of the left and right wheels, the controller being configured to allow the rotation speed of the left wheel to be adjusted to a first rotation speed and to allow the rotation speed of the right wheel to be simultaneously adjusted to a second rotation speed different from the first rotation speed to thereby cause the steering beam to pivot relative to the vehicle frame about the beam pivot axis when the left and right wheels contact the ground surface.

2. The steering assembly as claimed in claim 1, wherein the beam pivot axis extends at an angle relative to a vertical axis which extends orthogonally to the ground surface when the left and right wheels contact the ground surface.

3. The steering assembly as claimed in claim 2, wherein the beam pivot axis is angled such that it slopes down from one of the front and rear ends of the vehicle frame towards the other one of the front and rear ends of the vehicle frame.

4. The steering assembly as claimed in claim 3, wherein the beam pivot axis is angled at a pivot angle of between about 0 degrees and 45 degrees relative to the vertical axis.

5. The steering assembly as claimed in claim 4, wherein the beam pivot axis is angled at a pivot angle of about 15 degrees relative to the vertical axis.

6. (canceled)

7. The steering assembly as claimed in claim 1, further comprising a pivot axle extending along the beam pivot axis and pivotably connecting the steering beam to the vehicle frame.

8. The steering assembly as claimed in claim 7, wherein the vehicle frame defines a median longitudinal plane extending orthogonally to the ground surface when the vehicle is travelling forward on the ground surface, the pivot axle extending along the median longitudinal plane.

9. The steering assembly as claimed in claim 7, further comprising a bracket secured to the vehicle frame for receiving the pivot axle and for restricting movement of the pivot axle to allow only rotation of the pivot axle about the beam pivot axis.

10.-12. (canceled)

13. The steering assembly as claimed in claim 9, further comprising a resilient member operatively connected to the steering beam and to the bracket to urge the steering beam back towards a forward-facing orientation when the steering beam is pivoted about the beam pivot axis away from the forward-facing orientation.

14. The steering assembly as claimed in claim 13, wherein the resilient element includes a torsion spring concentrically mounted around the pivot axle.

15. The steering assembly as claimed in claim 7, wherein the steering beam includes a central sleeve sized and shaped for receiving the pivot axle, and left and right steering arms hingeably connected to the central sleeve.

16. The steering assembly as claimed in claim 15, further comprising a leaf spring member resiliently connecting together the left and right steering arms to the central sleeve.

17. The steering assembly as claimed in claim 15, wherein each steering arm includes a wheel mounting body engaging a corresponding wheel and upper and lower arm members extending between the central sleeve and the wheel mounting body, the upper and lower arm members being hingeably connected to the central sleeve and to the wheel mounting body so as to define a four-bar linkage arrangement for allowing the corresponding wheel to move upwardly and downwardly relative to the central sleeve.

18. (canceled)

19. The steering assembly as claimed in claim 1, wherein the first and second motors include wheel hub motors.

20.-29. (canceled)

30. A vehicle comprising:
a vehicle frame having a front end and a rear end;
a steering assembly including a front steering subassembly secured to the front end of the frame and a rear steering subassembly secured to the rear end of the frame, each one of the front and rear steering subassemblies including:
a steering beam having a left end and a right end, the steering beam being pivotably connectable to the vehicle frame such that the left end is located towards a left side of the vehicle and the right end is located towards a right side of the vehicle, the steering beam being configured to pivot relative to the vehicle frame about a beam pivot axis located between the first and second ends of the steering beam and extending through the steering beam;
left and right wheels rotatably connected to the steering beam respectively at the left and right ends thereof, the left and right wheels being rotatable relative to the steering beam respectively about left and right wheel axes extending away from the steering beam, the left and right wheels maintaining the left and right ends of the steering beam in a beam plane parallel to the ground surface when the left and right wheels contact the ground surface such that, when the steering beam is pivoted, the left and right ends of the steering beam move around the beam pivot axis while remaining within the beam plane;
a left wheel motor secured to the steering beam at the left end thereof, the left wheel motor being operatively connected to the left wheel for rotating the left wheel;
a right wheel motor secured to the steering beam at the right end thereof, the right wheel motor being operatively connected to the right wheel for rotating the right wheel;
a controller operatively connected to the first and second motors of the front subassembly and to the first and second motors of the rear subassembly for controlling a rotation speed of the left and right wheels of the front and rear steering subassemblies, the controller being configured to allow the rotation speed of the left wheel of the front steering subassembly to be adjusted to a first rotation speed and to allow the rotation speed of the right wheel of the front steering subassembly to be simultaneously adjusted to a second rotation speed different from the first rotation speed to cause the steering beam of the front steering subassembly to pivot relative to the frame about the corresponding beam pivot axis in a first pivot direction when the left and right wheels contact a ground surface, the controller being further configured to allow the left wheel of the rear steering assembly to be adjusted to a third rotation speed and to allow the rotation speed of the right wheel of the rear steering assembly to be simultaneously adjusted to a fourth rotation speed different from the third rotation speed to cause the steering beam of the rear steering subassembly to pivot relative to the vehicle frame about the corresponding beam pivot axis in a second pivot direction opposite the first pivot direction when the left and right wheels contact the ground surface.

31. The vehicle as claimed in claim 30, wherein each beam pivot axis extends at an angle relative to a vertical axis which extends orthogonally to the ground surface when the left and right wheels contact the ground surface.

32. The vehicle as claimed in claim 31, wherein the beam pivot axis of the front steering subassembly is angled such that it slopes down from the front end of the vehicle frame towards the rear end of the vehicle frame.

33. The vehicle as claimed in claim 32, wherein the beam pivot axis of the rear steering subassembly is angled such that it slopes down from the rear end of the vehicle frame towards the front end of the vehicle frame.

34. The vehicle as claimed in claim 33, wherein the beam pivot axes of both the front and rear steering subassemblies are angled at a pivot angle of between about 0 degrees and 45 degrees relative to the vertical axis.

35. The vehicle as claimed in claim 34, wherein the beam pivot axes of both the front and rear steering subassemblies are angled at a pivot angle of about 15 degrees relative to the vertical axis.

36. A method for controlling motion of a vehicle travelling on a ground surface, the method comprising:
providing a steering assembly for the vehicle, the steering assembly including a steering beam being pivotably connected to a vehicle frame of the vehicle, the steering beam having left and right ends, the steering assembly further including left and right wheels rotatably mounted respectively to left and right ends of the steering beam, the left and right wheels being rotatable relative to the steering beam respectively about left and right wheel axes extending away from the steering beam, the left and right wheels maintaining the left and right ends of the steering beam in a beam plane parallel to the ground surface;
adjusting a rotation speed of the left wheel to a first rotation speed;
adjusting a rotation speed of the right wheel to a second rotation speed different from the first speed to thereby cause the steering beam to pivot relative to the vehicle frame about a beam pivot axis extending through the steering beam such that the left and right ends of the steering beam move around the beam pivot axis while remaining within the beam plane.

37. The method as claimed in claim 36, wherein the adjusting of the rotation speed of the right wheel to the second rotation speed is simultaneous to the adjusting of the rotation speed of the left wheel to the first rotation speed.

38. (canceled)

39. The method as claimed in claim 36, further comprising:
using a vibration sensor, measuring vibrations in at least one of the left and right wheels and the vehicle frame over a period of time;
determining a vibration frequency of the vibrations based on the measured vibrations;
modulating the rotation speed of at least one of the left and right wheels according to the determined vibration frequency to thereby damp vibrations in the at least one of the left and right wheels and the vehicle frame.

40. The method as claimed in claim 36, wherein the beam pivot axis is angled such that it slopes down from one of a front end and a rear end of the vehicle frame towards the other one of the front and rear ends of the vehicle frame.
